(19) United States
(12) Patent Application Publication
(10) Pub. No.: US 2026/0228661 A1
(43) Pub. Date: Aug. 6, 2026

(54) PLAN CREATION SYSTEM, PLAN CREATION METHOD, PROGRAM, AND TRAINING DEVICE

(71) Applicant: NEC Corporation, Tokyo (JP)

(72) Inventors: Satoshi ODA, Tokyo (JP); Takeshi AKAGAWA, Tokyo (JP); Hideki KOMORI, Tokyo (JP)

(73) Assignee: NEC Corporation, Tokyo (JP)

(21) Appl. No.: 19/151,699

(22) PCT Filed: Dec. 12, 2023
(86) PCT No.: PCT/JP2023/044341

§ 371 Date: Jul. 29, 2025

(30) Foreign Application Priority Data
Feb. 9, 2023 (JP) 2023-018764

(51) Int. Cl. G06Q 10/0631

(52) U.S. Cl. CPC G06Q 10/06313

(57) ABSTRACT

This plan creation system comprises: an information reception unit that receives plan creation information including a classification and at least one of a goal, a delivery deadline, and a budget of a new project to be created; a plan creation unit that creates a plan about the received plan creation information by using a trained model which has been trained to output a plan for a project including one or more tasks for realizing the new project, by using, as inputs, actual result data including the classification, and at least one of the goal, the delivery deadline, and the budget, of a past project and the classification of one or more actual result tasks in which at least one of the goal, the delivery deadline, and the budget have been achieved; and an output unit that outputs the created plan.

### TECHNICAL FIELD

The present disclosure relates to a plan creation system, a plan creation method, a program, and a training device.

### BACKGROUND ART

A plurality of members having different skills participate in a project for achieving a predetermined goal. Various tools exist to manage such a project.

PTL 1 discloses a prediction model that derives management items for project determination and unknown answer results for the management items for project determination using, as training data, a combination of the management items for project management and management items of the determined project, by employing various algorithms for machine learning such as a neural network. Examples of the management items for project determination include a project name, the classification of a project, details, a budget, the area, and a construction period, and examples of the management items of the determined project include personnel accumulated as actual results in an actual project and the corresponding job descriptions, a period, and a cost.

### CITATION LIST

### Patent Literature

PTL 1: JP 2021-144756 A

### SUMMARY OF INVENTION

### Technical Problem

However, it is difficult for a person having little knowledge or experience regarding a project to create a project plan.

The present disclosure has been made to solve such a problem, and an object thereof is to provide a plan creation system and the like capable of creating a project plan.

According to an aspect of the present disclosure, there is provided a plan creation system including:
an information reception unit for receiving plan creation information including the classification of a new project to be created and at least one of a goal, a delivery deadline, or a budget;
a plan creation unit for creating a plan based on the received plan creation information by using a trained model trained to output a plan for a project including one or more tasks for implementing the new project using, as inputs, actual result data including the classification of a past project, at least one of the goal, the delivery deadline, or the budget of the past project, and the classification of one or more actual result tasks which have achieved at least one of the goal, the delivery deadline, or the budget; and
an output unit for outputting the created plan.

According to another aspect of the present disclosure, there is provided a plan creation method including:
receiving plan creation information including the classification of a new project to be created and at least one of a goal, a delivery deadline, or a budget;
creating a plan based on the received plan creation information by using a trained model trained to output a plan for a project including one or more tasks for implementing the new project using, as inputs, actual result data including the classification of a past project, at least one of the goal, the delivery deadline, or the budget of the past project, and the classification of one or more actual result tasks which have achieved at least one of the goal, the delivery deadline, or the budget; and
outputting the created plan.

According to still another aspect of the present disclosure, there is provided a program causing a computer to execute processing of:
receiving plan creation information including a classification of a new project to be created and at least one of a goal, a delivery deadline, or a budget of the new project;
creating a plan based on the received plan creation information by using a trained model trained to output a plan for a project including one or more tasks for implementing the new project using, as inputs, actual result data including a classification of a past project, at least one of a goal, a delivery deadline, or a budget of the past project, and the classification of one or more actual result tasks in which at least one of the goal, the delivery deadline, or the budget of the past project have been achieved; and
outputting the created plan.

According to still another aspect of the present disclosure, there is provided a training device including:
a training data acquisition unit for acquiring training data that is actual result data including a classification of a past project, at least one of a goal, a delivery deadline, or a budget of the past project, and the classification of one or more actual result tasks in which at least one of the goal, the delivery deadline, or the budget of the past project have been achieved; and
a training unit for generating a trained model trained to output a plan for a project including one or more tasks for implementing the new project using the training data as an input.

The present disclosure can provide a plan creation system and the like that can create a plan for a project.

### BRIEF DESCRIPTION OF DRAWINGS

FIG. 1 is a block diagram illustrating an example of a plan creation system according to the present disclosure.

FIG. 2 is a flowchart illustrating a plan creation method according to the present disclosure.

FIG. 3 is a block diagram illustrating an example of a training device according to the present disclosure.

FIG. 4 is a flowchart illustrating an example of a training method according to the present disclosure.

FIG. 5 is a diagram illustrating an example indicating a trained model and training data according to the present disclosure.

FIG. 6 is a diagram illustrating an example indicating a configuration of a plan creation system, input items, and output items according to the present disclosure.

FIG. 7 is a diagram illustrating an example of a Gantt chart according to the present disclosure.

FIG. 8 is a block diagram of a plan creation system according to the present disclosure.

FIG. 9 is a block diagram illustrating a hardware configuration example of a plan creation device.

### EXAMPLE EMBODIMENT

Hereinafter, the present example embodiments will be described with reference to the drawings.

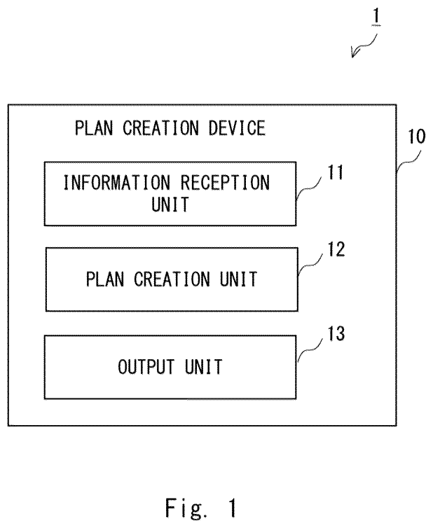

FIG. 1 is a block diagram of a plan creation system according to the present disclosure.

A plan creation system 1 can be used to create a plan for a project. The project is a plan that includes one or more tasks and in which a plurality of members participate. The task is a work unit that constitutes a project. The task may be a simple work that does not require specialized skills, or may be a work that requires specialized skills and proficiency. A plurality of the members may or may not have various specialized skills. Project participants may include two or more members (for example, two software engineers) having the same skills. A project may involve a plurality of members having different skills.

The project can be managed by a project manager. Members having different skills include a software engineer, a hardware engineer, a researcher, an analyst, and a knowledge expert, but are not limited to these. Each of the members may belong to one company or may not belong to one company to participate in the project as a freelance.

In general, as the project is larger, the project consists of a plurality of tasks, and a plurality of participants are required, or a plurality of participants having different skills are required, it is difficult to create a plan for the project. The plan creation system 1 according to the present disclosure supports creation of a plan for a project similar to a past project by utilizing a database (also referred to as a process mining tool) in which the past projects are accumulated.

The plan creation system 1 can include one or more plan creation devices 10. The plan creation device 10 can be implemented by one or more computers including one or more memories and one or more processors. As illustrated in FIG. 1, the plan creation device 10 can include an information reception unit 11, a plan creation unit 12, and an output unit 13. A control unit also functions as a function processing unit that executes each of the subdivided processes. In some example embodiments, some of the components (or functions) may be executed by another computer other than the plan creation device 10.

The information reception unit 11 receives, for example, plan creation information including the classification of a new project to be created and at least one of a goal, a delivery deadline, or a budget via an input interface (from the user). In some example embodiments, the information reception unit 11 may receive, for example, plan creation information including all of the classification of the new project to be created, the goal, the delivery deadline, and the budget via the input interface. In other example embodiments, the goal may include completing the project within a delivery deadline or within a budget. In other example embodiments, the delivery deadline and the budget may be received together with their importance (for example, mandatory, need to be considered, and the like). As an example of the importance, meeting the delivery deadline is mandatory, and the budget may be necessary to be considered. As another example of the importance, meeting the delivery deadline is necessary to be considered, and the budget may be mandatory. As an example of the importance, meeting the delivery deadline is mandatory, and the budget may be necessary to be considered. A plan creation unit to be described later selectively creates a plurality of various plans that satisfy or do not satisfy the to-be-considered item while satisfying the mandatory item.

Examples of the classification of a project include a consulting project, a business improvement project, a sales improvement project, a research and development project, a joint research project, an invention discovery project, a manufacturing project of electrical appliances, furniture, or the like, startup due diligence, an overseas market survey, an end-user survey, a revenue model design, and a design of a rebate program for distributors in various industries, but are not limited to these. The classifications of projects can be given for different industries. The goal of the project can include, for example, improving sales, reducing costs, enhancing profitability, and expanding the sales network, but is not limited to these. As the delivery deadline, the user can set a specific date and time, a period, and the like. As the budget, the user can set specific amounts and the like. For the delivery deadline and the budget, as described above, the importance (for example, mandatory, need to be considered, and the like) can be set.

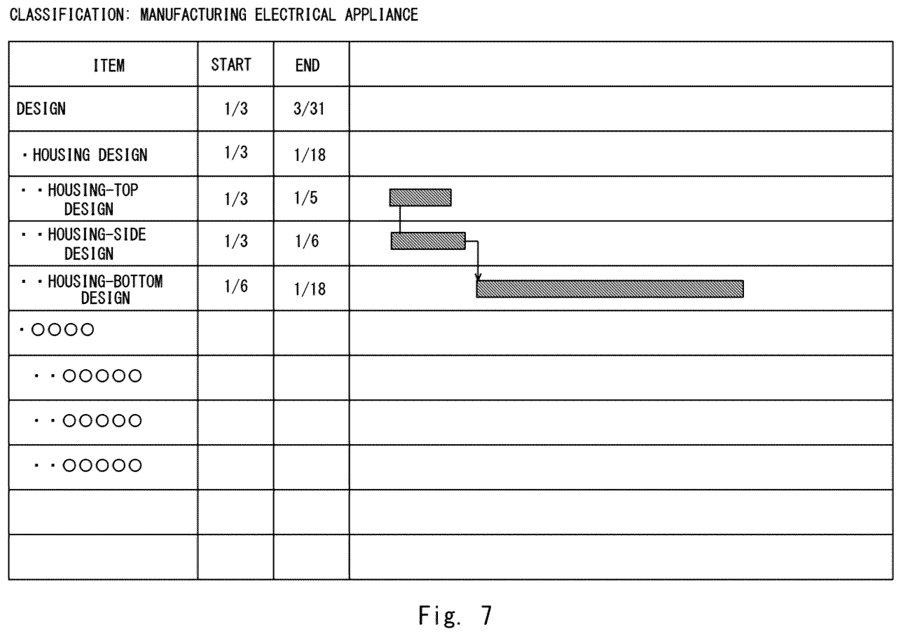

The plan creation unit 12 can use a machine learning model trained to output a plan for a project using, as inputs, actual result data including the classification of a past project, at least one of a goal, a delivery deadline, or a budget of the past project, and the classification of one or more actual result tasks that have achieved at least one of the goal, the delivery deadline, or the budget. The classification of the actual result task can be an item used for process mining. The classification of the actual result task can be a major item, a medium item, or a minor item of the task described in the Gantt chart (to be described later in FIG. 7) of the project. For example, in a case where the classification of the project is manufacturing electrical appliances, the classification of the actual result task can be as follows. There are Major item: design, Medium item: housing design, internal structure design, packaging design, and Minor item: housing-top design, housing-side design, housing-bottom design . . . , and the like. In some example embodiments, the information or classification of the actual result task can also indicate assignment information indicating to which worker having what specialized skills, proficiency, or work experience the task is assigned. The actual result task information can also indicate the man-hour information indicating how many workers have executed the task and how long the worker has executed the task. The actual result task information can include a workload per unit period (for example, one day) of one worker according to a level of proficiency including a simple work level. The simple work level refers to a work level that does not require special skills. The information or classification of the actual result task can indicate that a specific task (for example, translation work, debug, or the like) is assigned to a machine (that is, artificial intelligence or the like).

These are merely examples. The trained model can be updated every time a predetermined amount of past actual result data is accumulated. The latest trained model may be stored in a storage unit inside the plan creation device 10 or may be stored in a storage unit outside the plan creation device 10 connected via a network. The trained model is constructed, for each classification of the project, by training a neural network using, as training data, actual result data including at least one of a goal, a budget, or a delivery deadline of the past project and the classification of one or more actual result tasks that have achieved at least one of the goal, the budget, or the delivery deadline. This training method is also called supervised learning. In other example embodiments, other methods using the neural network may be used.

Using such a trained model, the plan creation unit 12 creates a plan including one or more tasks for implementing a new project based on the received plan creation information. The plan can include a plurality of tasks. The plan can include assignment information for assigning each task. The assignment information can include worker information having specific specialized skills, proficiency, or work experience. The assignment information can also include assignment to a person such as an employee, a temporary employee, or a member, or assignment to a machine. The plan creation unit 12 may create two or more plans.

The output unit 13 outputs the created plan. The output unit 13 may output two or more created plans. For example, the output unit 13 can cause a display screen of a computer to display a plurality of candidate plans in a comparable manner.

In some example embodiments, the information reception unit 11 receives the plan creation information including the classification of a new project to be created. In this case, the plan creation unit 12 can output a plan including a plurality of tasks having different granularities according to the classification of a new project to be created.

In another example embodiment, it is possible to use a machine learning model trained to output a plan for a project by using, as an input, actual result data including the classification and goal of the past project, the classifications of a plurality of actual result tasks that have achieved the goal, and a relationship among a plurality of the actual result tasks. In this case, the plan creation unit 12 can create a plan including an order relationship between two or more tasks or a parallel relationship between two or more tasks.

In still another example embodiment, it is possible to use a machine learning model trained to output a plan for a project by using, as an input, actual result data including the classification and goal of the past project, the classifications of a plurality of actual result tasks that have achieved the goal, a relationship among a plurality of the actual result tasks, and the required time of the actual result task (or the start time and the end time). The plan creation unit 12 can create a plan indicating the classifications of two or more tasks and the time and required time of each task.

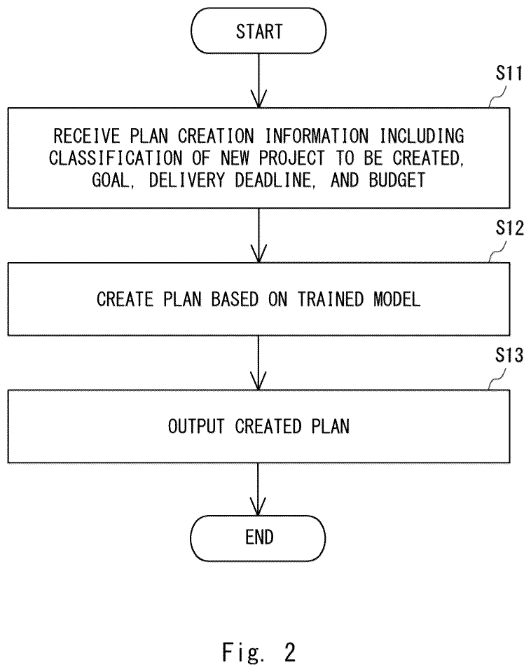

FIG. 2 is a flowchart illustrating a plan creation method.

The information reception unit 11 receives plan creation information including the classification of a new project to be created and at least one of a goal, a delivery deadline, or a budget (step S11). The plan creation unit 12 creates a plan for a project using the above-described trained model (step S12).

The output unit 13 outputs the created plan for a project (step S13).

According to the example embodiment described above, even a person having little knowledge or experience regarding a project can create a plan for a project. In some example embodiments, the plan can be updated in the middle of the project based on the actual results achieved by each member.

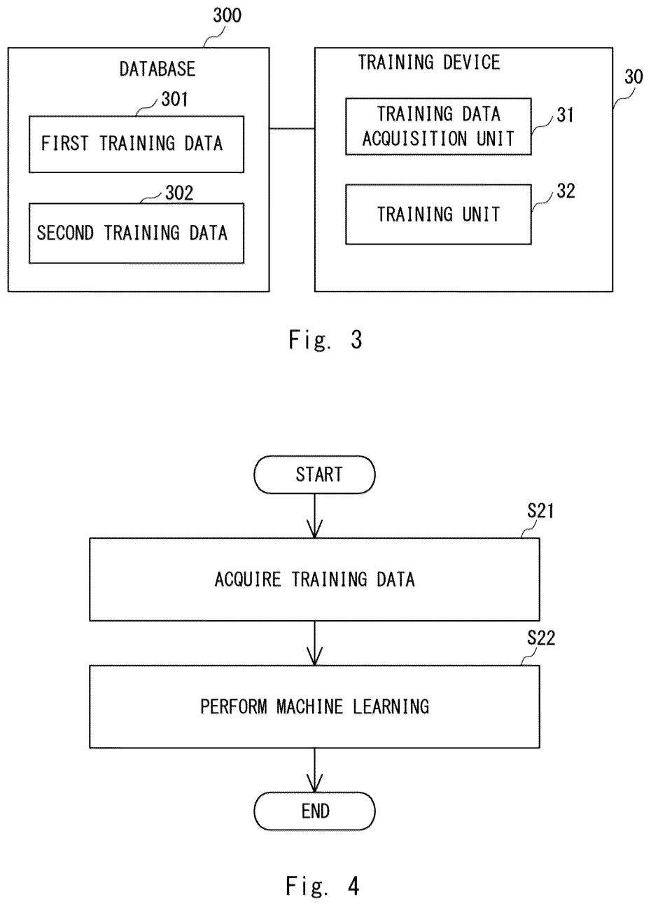

FIG. 3 is a block diagram illustrating an example of the training device.

A training device 30 can be used in a training stage of machine learning. The training device 30 can be connected to a database 300 that stores actual result data (training data) including the classification and goal of a past project and the classification of one or more actual result tasks that have achieved the goal. The database 300 can be connected to a training data acquisition unit 31 of the training device 30. The training device 30 can be implemented by one or more computers including a processor and a memory. The training device 30 includes a training data acquisition unit 31 and a training unit 32. The training data of the database 300 can be periodically updated every time a predetermined amount of data is accumulated. The training data can be classified into a plurality of pieces of training data (for example, first training data 301 and second training data 302). For example, the first training data is for decomposing a project into one or more tasks and creating a plan including a plurality of the decomposed tasks. The second training data is for creating a plan in which a plurality of the tasks are combined with time information. In other modified examples, different pieces of training data can be accumulated for different industries or for different projects.

The training data acquisition unit 31 acquires, from the database 300, actual result data including the classification of a past project, at least one of a goal, a delivery deadline, or a budget of the past project, and the classification of one or more actual result tasks that have achieved at least one of the goal, the delivery deadline, or the budget.

The training unit 32 receives the training data as an input, performs machine learning to output a plan for a project, and generates a trained model. In some example embodiments, the training unit 32 may generate different trained models (for example, a first trained model and a second trained model) for each different training data (for example, the first training data 301 and the second training data 302). The trained model can be stored in the storage unit of the plan creation device 10 or an external storage unit connected via the network. In other example embodiments, other methods using the neural network may be used.

In some example embodiments, the training device 30 can be connected to the database 300 that stores actual result data (training data) including the classification of a past project, at least one of a goal, a delivery deadline, or a budget, the classification of a plurality of actual result tasks that have achieved at least one of the goal, the delivery deadline, or the budget of the past project, and a relationship among a plurality of the actual result tasks. The training data acquisition unit 31 acquires, from the database 300, actual result data (second training data) including the classification of a past project, at least one of a goal, a delivery deadline, or a budget, the classification of a plurality of actual result tasks that have achieved at least one of the goal, the delivery deadline, or the budget of the past project, and a relationship among a plurality of the actual result tasks. The training unit 32 receives the training data as an input, performs machine learning to output a plan for a project, and generates a trained model (second trained model). In other modified examples, different trained models can be generated for different industries or for different projects.

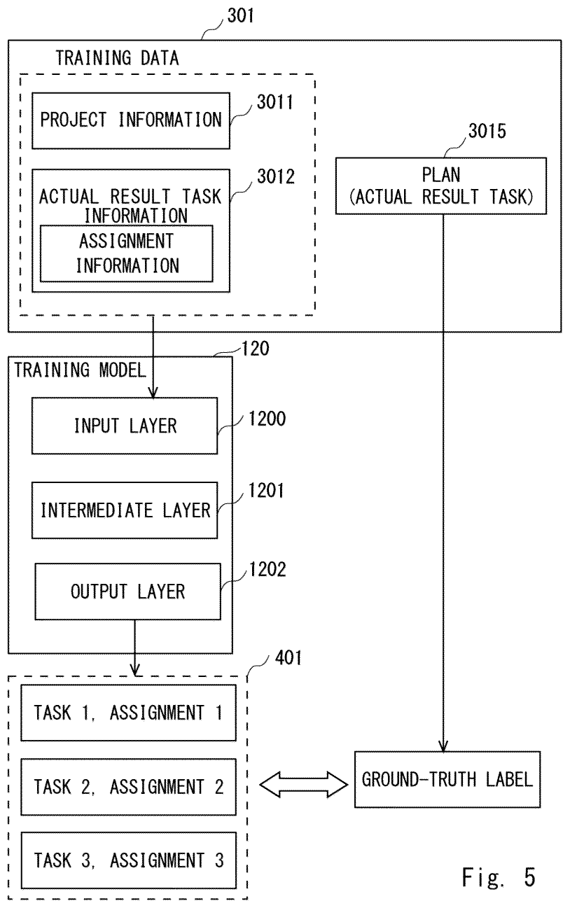

FIG. 4 is a flowchart illustrating a training method. FIG. 5 is a diagram illustrating an example indicating a trained model and training data.

Training data 301 used for training a training model in a machine learning manner includes project information 3011, actual result task information 3012, and information regarding a plan 3015.

The project information 3011 can include the classification of a project and at least one of a goal, a delivery deadline, or a budget of the project. The actual result task information 3012 can include the classification of actual result task, a relationship among the actual result tasks, the assignment information of the actual result task, the man-hour information (period, the number of workers, and the like) of the actual result task, and the cost of the actual result task. The assignment information indicates whether the task is assigned to a worker having a specific specialized skill or the like. The plan 3015 can be configured by combining one or more actual result tasks, and more specifically, can be configured in the form of a Gantt chart to be described later with reference to FIG. 7. The actual result task information 3012 can be metadata of a specifically used Gantt chart. The plan 3015, the combination of the actual result tasks, and the specifically used Gantt chart of a successful project (and its metadata), can be used as ground-truth labels.

The training data acquisition unit 31 acquires a predetermined amount of training data from the database 300 (step S21). Next, the training unit 32 performs machine learning using the training data (step S22). A training model 120 employs, for example, a structure of a neural network, and includes an input layer 1200, an intermediate layer 1201, and an output layer 1202. Synapses (not illustrated) connecting neurons are provided between the layers, and a set of weight parameters including the weights of the respective synapses is adjusted through machine learning.

The input layer 1200 includes neurons corresponding to the project information 3011 and the actual result task information 3012 as input data, and values indicated by the respective pieces of information are input to the neurons. The intermediate layer 1201 includes, for example, a plurality of layers. The output layer 1202 includes a number of neurons corresponding to each plan (combination and assignment of actual result tasks, and the like) as output data, and outputs each inference result of a plan 401 (combination and assignment of actual result tasks, and the like).

In the training device described above, it is possible to generate a trained model for creating a plan for a project in which a plurality of members having different skills participate. Different trained models can be generated for different industries or for different projects. The machine learning described above is merely an example, and various modified examples are possible. In other example embodiments, other methods using the neural network may be used.

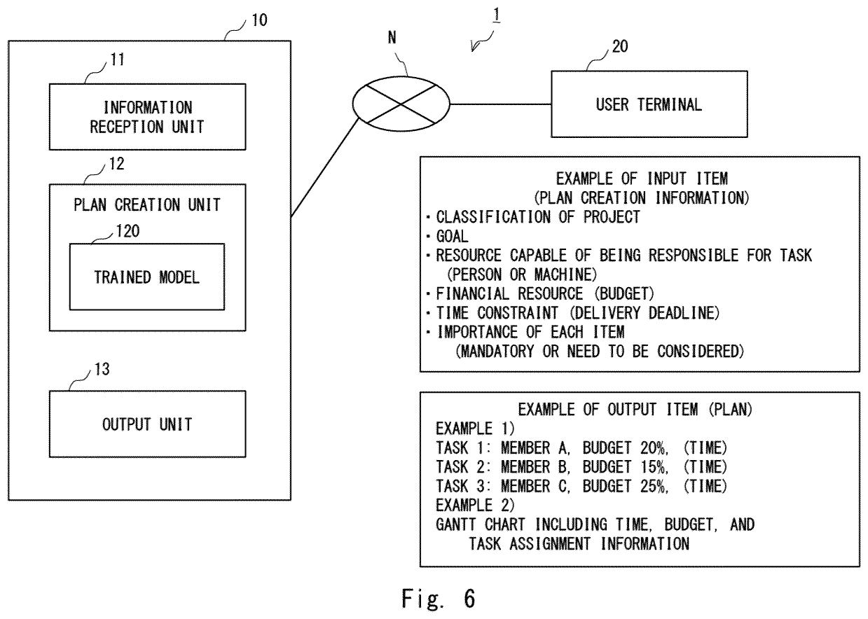

FIG. 6 is a block diagram illustrating an example of the plan creation system.

In the plan creation system 1 according to the present disclosure, a project manager or the like who intends to create a new project can create a plan for a project by providing input information (also referred to as plan creation information in some cases) regarding a project to be described later to the plan creation device 10 using his/her user terminal 20. Thus, the project manager can create one or more plans that can achieve the goal of the project and are suitable for the budget, human resources, and the like. As illustrated in FIG. 6, the plan creation system 1 includes the plan creation device 10 and the user terminal 20, which are connected to each other via a network N.

As described above, the plan creation device 10 can include the information reception unit 11, the plan creation unit 12, and the output unit 13. The user terminal 20 can be a computer device used by a user (for example, the project manager). The user terminal 20 can be any device such as a personal computer, a smartphone, or a wearable device.

The information reception unit 11 receives plan creation information, which is input information regarding a project, from the user terminal 20. The plan creation information includes the classification of a new project to be created, at least one of a goal, a delivery deadline, or a budget, or all of them. The classification of a project can be consultation for each industry (for example, a manufacturing industry, a service industry, and the like), but is not limited to these. The goal can be improving sales, enhancing profitability, reducing costs, enhancing customer satisfaction, and the like, but is not limited to these. The goal can be selected by the user from predetermined items. As the delivery deadline, the user can set a specific date and time or a period. As the budget, the user can set specific amounts and the like. For the delivery deadline and the budget, the importance (for example, mandatory, need to be considered, and the like) can be set. For example, in a case where the delivery deadline is mandatory and the budget is set to be considered, a plurality of plans can be created for a case where the budget is satisfied or not satisfied while the delivery deadline is strictly met.

The plan creation unit 12 creates a plan for a project using a trained model 120 based on the plan creation information as input information. The trained model 120 is trained to output a plan for a project using, as an input, actual result data including the classification of a past project, a goal, a budget, a delivery deadline, and one or more pieces of actual result task information that have achieved the goal, the budget, and the delivery deadline. The actual result task information includes the classification of the actual result task and a relationship among a plurality of the actual result tasks. The classification of the actual result task can be an item used for process mining. The classification of the actual result task can be a major item, a medium item, or a minor item of the task described in the Gantt chart of the project. The Gantt chart is a chart that visually expresses the management of the progress state of each task and the work plan in project management. The relationship among a plurality of the actual result tasks includes at least one of the presence or absence of a causal relationship among a plurality of the actual result tasks, a temporal order among a plurality of the actual result tasks, substitutability, or a relationship of a superordinate concept or a subordinate concept. In a case where there is a causal relationship among a plurality of actual result tasks, the plurality of actual result tasks need to be executed in order according to the causal relationship. In a case where there is no causal relationship among a plurality of actual result tasks, the plurality of actual result tasks can be processed in parallel. The actual result task information includes allocation information of each task and man-hour information (a work period and the number of workers) that has achieved each task.

The output unit 13 can transmit data related to the plan created by the plan creation device 10 to the user terminal 20 via the network and cause the display of the user terminal 20 to display the plan. For example, the project manager can browse a plurality of plan candidates using the user terminal 20 and select the most appropriate one of the plans. For example, in a case where the delivery deadline is mandatory and the budget is set to be considered, a plurality of plans can be created for a case where the budget is satisfied or not satisfied while the delivery deadline is strictly met. Among them, the project manager can compare the magnitude of the budgets and select a plan with an optimal budget. Each task of the output plan may indicate assignment information for a worker having specific specialized skills or a machine (such as artificial intelligence) other than the worker. Each task of the output plan may indicate cost including labor cost and the like. Each task of the output plan may indicate whether the budget of the plan creation information is satisfied. Each task of the output plan may indicate whether the delivery deadline of the plan creation information is satisfied.

FIG. 6 also illustrates an example of input items (plan creation information) to the information reception unit 11.

The project manager inputs the input items illustrated in FIG. 6 to the information reception unit 11 of the plan creation device 10 using the user terminal 20. The project manager can easily input the following information by selecting a selection item on a predetermined user interface. For example, the input items include the classification of a project, a goal to be achieved in the project, availability of a resource capable of being responsible for a task (for example, an employee, a temporary employee, a member, or a machine), a financial resource (budget), a time constraint (delivery deadline), and importance (for example, mandatory or need to be considered) of each item.

FIG. 6 also illustrates an example of the output item.

As the example of the output plan, a member A having specific specialized skills, and 20% of the total budget are provided for Task 1. A member B having specific specialized skills, and 15% of the total budget are provided for Task 2. A member C having specific specialized skills, and 25% of the total budget are provided for Task 3. This plan is merely an example in which a project is decomposed into a plurality of tasks constituting the project and each task is assigned to a person having specialized skills. The project can be decomposed into a plurality of tasks for achieving the goal at a granularity corresponding to the classification of the project. That is, the granularity of the task to be decomposed can be different according to the classification of the project. For example, the plan in the case of cost reduction (goal) in the automobile manufacturing industry (classification) can include tasks with finer granularity than the plan in the case of cost reduction (goal) in the IT manufacturing industry (classification).

A simple task or a task for a skilled worker can be considered in the decomposition into the tasks. The simple task is a task that can be performed by a person who does not have specialized knowledge, and can define a task amount that can be performed per day. For example, in a case where the delivery deadline is one week and three workers can be secured, it can be determined whether one or more simple tasks among the tasks for achieving the goal can be performed.

In the case of a skilled worker task, how a skilled worker can perform a similar task can be learned from data of a database using a process mining tool indicating a task performed in the past. “Process mining” is a method for acquiring and analyzing logs of various work activities performed by employees in a company, and visualizing work processes to grasp the current situation and utilize the grasped situation for work improvement. A person inputs data in the process mining to the database.

As an example of another plan, a member A having specific specialized skills, 20% of the total budget, and a first week (first one week) can be provided for Task 1. A member B having specific specialized skills, and 15% of the total budget, and a second week (next one week) can be provided for Task 2. A member C having specific specialized skills, and 25% of the total budget, and a third week (final one week) can be provided for Task 3. This plan indicates that Task 1, Task 2, and Task 3 need to be executed in this order since the tasks have a causal relationship. Different work periods can be indicated for each task. In another example, since Task 1 and Task 2 do not have a causal relationship, it may indicate that parallel processing is possible.

FIG. 7 is a diagram illustrating an example of a Gantt chart.

In the Gantt chart, item names (for example, a major item, a medium item, a minor item, and the like) of the task are indicated, and a start time of the task and an end time of the task can be indicated. Relationship among tasks (for example, the parallel processing is possible, or there is a causal relationship) can be indicated.

In another example, the plan can be output in the form of the Gantt chart illustrated in FIG. 7. The Gantt chart can also include times of tasks (start and end), a task assignment, and a budget spent on each task. The person in charge of the task can be an employee, a temporary employee, a member, a machine, or the like. Examples of the task that can be handled by the machine include machine translation, creation of images by AI, debugging in programming, and other simple works, but are not limited to these. The output plan can be displayed to identify whether the person is in charge of the task or the machine handles the task. In this case, in a case where the project manager selects a person or a machine, the plan can indicate a different budget and delivery deadline depending on the person or machine.

In another example, AI (also referred to as white-box AI) capable of explaining the discovered rules or patterns can be used. The output data may also indicate the basis and causal relationship (cause and result) of the created plan. For example, it can indicate which task has a bottleneck in order to achieve the goal, budget or delivery deadline. It may indicate the differences compared to the training data. In a case where a task is missing, the missing of the task may be pointed out.

After inputting the plan creation information, the project manager can select an appropriate trained model. For example, it is also possible to select a trained model for each classification of the project (for example, consulting for a particular industry). It is also possible to select a trained model for decomposing a project into a plurality of tasks or a trained model for decomposing a project into a plurality of tasks and defining the order of the plurality of tasks (including whether parallel processing is possible).

The present example embodiment can be used in a case where a project progresses partway and a plan is reconstructed after some tasks are completed.

The plan creation information can include a progress state for each task. For example, there is a plan in which Task 1, Task 2, and Task 3 are performed in order in order to achieve the goal of the project. In a case where the progress state of Task 1 indicates that the member A has completed Task 1, a plan can be created again using a specific trained model in consideration of the cost spent on Task 1, the work time, and the like. In another example embodiment, the plan creation information can include information regarding an environmental change including a worker change, a delivery deadline change, and a specification change that occur in the middle of a project. The plan creation unit 12 may reconstruct the plan in consideration of the environmental change including the worker change, the delivery deadline change, the specification change, and the like that occur in the middle of the project.

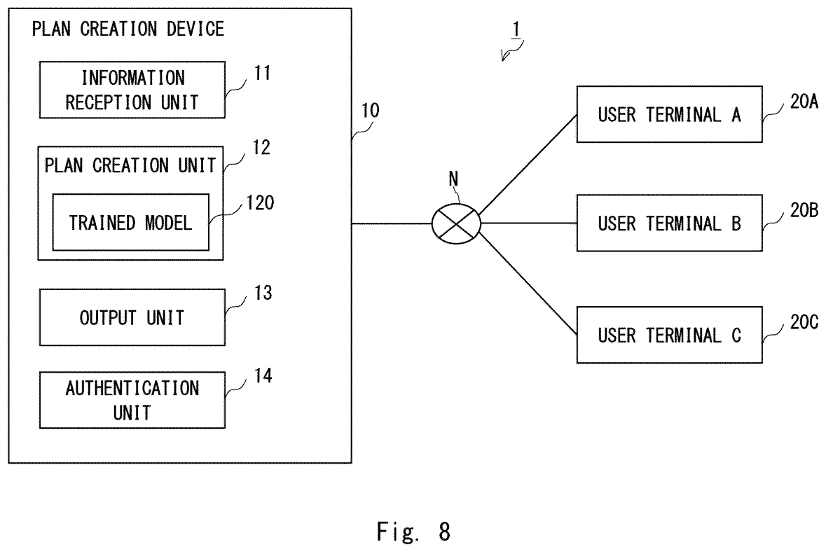

FIG. 8 is a block diagram of a plan creation system according to the present disclosure.

The plan creation system 1 according to the present example embodiment includes the plan creation device 10 and a plurality of user terminals 20A to 20C, which are connected to each other via the network N. A plurality of the user terminals can be used by users with different authorities. The present example embodiment is effective in a case where a project is executed by a plurality of participants using the user terminals in a decentralized autonomous organization (DAO).

Unlike the above-described example embodiment, the plan creation device 10 according to the present disclosure includes an authentication unit 14 for authenticating a user terminal. Components other than the authentication unit 14 are basically the same.

The authentication unit 14 authenticates the user terminal of the member participating in the project. For example, the authentication unit 14 can authenticate the user terminal of the member by an arbitrary authentication method such as a user ID or a password. The authentication unit 14 can authenticate the user terminal at different authentication levels of the user terminal according to the authorization level given to the member. For example, as described above, a user terminal 20N can be authenticated at the authorization level of the project manager. On the other hand, the user terminals 20A, 20B, and 20C can be authenticated at the authorization level of the project participants.

The output unit 13 can also output the created plan to each user terminal. Each user can also report the completion of the project to the plan creation device 10 when the task assigned to the user is completed using each user terminal.

The information reception unit 11 receives plan creation information, which is input information regarding a project, from the user terminal 20, and receives a progress state of a project indicating whether each task is completed, a cost, a work time, and the like from each user terminal as needed after the project is started.

The plan creation unit 12 creates a plan for a project using the trained model 120 based on the plan creation information as input information. In this case, the trained model 120 is trained in consideration of the progress state of each actual result task. Thus, the plan creation unit 12 can create a plan again using a specific trained model in consideration of the cost spent on Task 1, the work time, and the like.

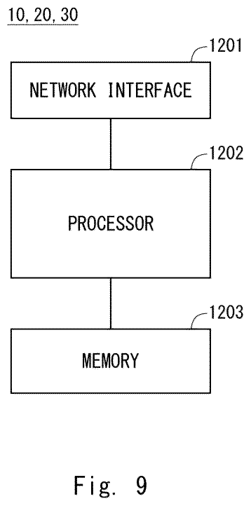

FIG. 9 is a block diagram illustrating a configuration example of hardware of the plan creation device 10, the user terminal 20, the training device 30, and the like (hereinafter, the plan creation device 10 and the like).

Referring to FIG. 9, the plan creation device 10 and the like include a network interface 1201, a processor 1202, and a memory 1203. The network interface 1201 is used to communicate with other network node devices that constitute a communications system. The network interface 1201 may be used to perform wireless communication. For example, the network interface 1201 may be used to perform wireless LAN communication specified in IEEE 802.11 series or mobile communication specified in the 3rd Generation Partnership Project (3GPP) (registered trademark). Alternatively, the network interface 1201 may include, for example, a network interface card (NIC) in conformity with IEEE 802.3 series.

The processor 1202 performs processing of the plan creation device 10 or the like described with reference to the flowchart or sequence in the above-described example embodiment by reading and executing software (computer program) from the memory 1203. The processor 1202 may be, for example, a microprocessor, a micro processing unit (MPU), a graphic processing unit (GPU), a digital signal processor (DSP), or a central processing unit (CPU). The processor 1202 may include a plurality of processors.

The memory 1203 includes a combination of a volatile memory and a nonvolatile memory. The memory 1203 may include a storage disposed away from the processor 1202. In this case, the processor 1202 may access the memory 1203 through an I/O interface (not illustrated).

In the example of FIG. 9, the memory 1203 is used to store a group of software modules. The processor 1202 can perform processing of the plan creation device 10 and the like described in the above-described example embodiments by reading the group of software modules from the memory 1203 and executing the group of software modules.

As described with reference to FIG. 2 or FIG. 4, each of the processors included in the plan creation device 10 and the like executes one or a plurality of programs including a command group for causing a computer to perform the algorithm described with reference to the drawings.

In the example described above, the program includes a command group (or software codes) for causing a computer to execute one or more functions described in the example embodiments in a case where the program is read by the computer. The program may be stored in a non-transitory computer-readable medium or a tangible storage medium. As an example and not by way of limitation, the computer-readable medium or the tangible storage medium includes a random access memory (RAM), a read only memory (ROM), a flash memory, a solid-state drive (SSD) or any other memory technology, a CD-ROM, a digital versatile disc (DVD), a Blu-ray (registered trademark) disc or any other optical disk storage, a magnetic cassette, a magnetic tape, a magnetic disk storage, and any other magnetic storage device. The program may be transmitted through a transitory computer-readable medium or a communication medium. As an example and not by way of limitation, the transitory computer-readable medium or the communication medium includes propagated signals in electrical, optical, acoustic, or other forms.

The present invention is not limited to the above example embodiment, and can be appropriately changed without departing from the gist. Some example embodiments can be appropriately combined with other example embodiments.

Some or all of the above-described example embodiments may be described as the following supplementary notes, but are not limited to the following supplementary notes.

### Supplementary Note 1

A plan creation system including:
an information reception unit for receiving plan creation information including a classification of a new project to be created and at least one of a goal, a delivery deadline, or a budget of the new project;
a plan creation unit for creating a plan based on the received plan creation information by using a trained model trained to output a plan for a project including one or more tasks for implementing the new project using, as inputs, actual result data including the classification of a past project, at least one of the goal, the delivery deadline, or the budget of the past project, and the classification of one or more actual result tasks which have achieved at least one of the goal, the delivery deadline, or the budget; and
an output unit for outputting the created plan.

### Supplementary Note 2

The plan creation system according to Supplementary Note 1, in which the plan creation unit outputs a plan including a plurality of tasks having different granularities according to the classification of the new project to be created.

### Supplementary Note 3

The plan creation system according to Supplementary Note 1, in which the classification of the actual result task includes a major item and a minor item included in the major item.

### Supplementary Note 4

The plan creation system according to Supplementary Note 1, in which
a plurality of the actual result tasks that have achieved the goal of the past project includes a relationship among the plurality of actual result tasks, and
the plan creation unit creates a plan including an order relationship between two or more tasks or a parallel relationship between two or more tasks.

### Supplementary Note 5

The plan creation system according to Supplementary Note 4, in which the relationship among the plurality of actual result tasks that have achieved the goal of the past project includes at least one of presence or absence of a causal relationship among the plurality of actual result tasks, a temporal order among the plurality of actual result tasks, or a relationship of a superordinate concept or a subordinate concept.

### Supplementary Note 6

The plan creation system according to Supplementary Note 1, in which information regarding the actual result task includes a level of proficiency of a worker including a simple work level.

### Supplementary Note 7

The plan creation system according to Supplementary Note 6, in which the information regarding the actual result task includes a workload per unit period of one worker according to the level of the proficiency.

### Supplementary Note 8

The plan creation system according to Supplementary Note 1, in which
the plan creation information includes information regarding a progress state, a worker change, a delivery deadline change, and a specification change for each task indicating whether some of the tasks after the project progresses are completed, and
the plan creation unit reconstructs a plan in consideration of the progress state, the worker change, the delivery deadline change, and the specification change for each task.

### Supplementary Note 9

The plan creation system according to Supplementary Note 1, in which the plan includes task assignment information for a person or a machine.

### Supplementary Note 10

The plan creation system according to Supplementary Note 1, in which the plan creation unit creates a plurality of plans, and each of the plans includes information regarding whether each of the received delivery deadline and budget is satisfied.

### Supplementary Note 11

A plan creation method including:
receiving plan creation information including a classification of a new project to be created and at least one of a goal, a delivery deadline, or a budget of the new project;
creating a plan based on the received plan creation information by using a trained model trained to output a plan for a project including one or more tasks for implementing the new project using, as inputs, actual result data including a classification of a past project, at least one of a goal, a delivery deadline, or a budget of the past project, and the classification of one or more actual result tasks in which at least one of the goal, the delivery deadline, or the budget of the past project have been achieved; and
outputting the created plan.

### Supplementary Note 12

A program causing a computer to execute processing of:
receiving plan creation information including a classification of a new project to be created and at least one of a goal, a delivery deadline, or a budget of the new project;
creating a plan based on the received plan creation information by using a trained model trained to output a plan for a project including one or more tasks for implementing the new project using, as inputs, actual result data including a classification of a past project, at least one of a goal, a delivery deadline, or a budget, and the classification of one or more actual result tasks in which at least one of the goal, the delivery deadline, or the budget of the past project have been achieved; and
outputting the created plan.

### Supplementary Note 13

A training device including:
a training data acquisition unit for acquiring training data that is actual result data including a classification of a past project, at least one of a goal, a delivery deadline, or a budget of the past project, and the classification of one or more actual result tasks in which at least one of the goal, the delivery deadline, or the budget of the past project have been achieved; and
a training unit for generating a trained model trained to output a plan for a project including one or more tasks for implementing the new project using the training data as an input.

Some or all of the elements (for example, configurations and functions) described in Supplementary Notes 2 to 10 dependent from the system of Supplementary Note 1 can be dependent from the method of Supplementary Note 11 and the program of Supplementary Note 12 as well with depending relationships similar to those of Supplementary Notes 2 to 10. Some or all of the elements described in any supplementary note can be applied to various types of hardware, software, a recording means for recording software, a system, and a method.

While the invention of the present application has been particularly shown and described with reference to example embodiments thereof, the invention of the present application is not limited to the above. It will be understood by those of ordinary skill in the art that various changes in form and details may be made therein without departing from the spirit and scope of the invention of the present application as defined by the claims.

This application is based upon and claims the benefit of priority from Japanese Patent Application No. 2023-018764, filed on Feb. 9, 2023, the disclosure of which is incorporated herein in its entirety by reference.

### REFERENCE SIGNS LIST

1 plan creation system
10 plan creation device
11 information reception unit
12 plan creation unit
13 output unit
20 user terminal
30 training device
31 training data acquisition unit
32 training unit
120 trained model
300 database
301 first training data
302 second training data

What is claimed is:

1. A plan creation system comprising:
at least one memory storing instructions, and
at least one processor configured to execute the instructions to;
receive plan creation information including a classification of a new project to be created and at least one of a goal, a delivery deadline, or a budget of the new project;
create a plan based on the received plan creation information by using a trained model trained to output a plan for a project including one or more tasks for implementing the new project using, as inputs, actual result data including a classification of a past project, at least one of a goal, a delivery deadline, or a budget of the past project, and the classification of one or more actual result tasks in which at least one of the goal, the delivery deadline, or the budget of the past project have been achieved; and
output the created plan.

2. The plan creation system according to claim 1, wherein the at least one processor is configured to execute the instructions to create a plan including a plurality of tasks having different granularities according to the classification of the new project to be created.

3. The plan creation system according to claim 1, wherein
a plurality of the actual result tasks that have achieved the goal of the past project includes a relationship among the plurality of actual result tasks, and
the at least one processor is configured to execute the instructions to create a plan including an order relationship between two or more tasks or a parallel relationship between two or more tasks.

4. The plan creation system according to claim 3, wherein the relationship among the plurality of actual result tasks that have achieved the goal of the past project includes at least one of presence or absence of a causal relationship among the plurality of actual result tasks, a temporal order among the plurality of actual result tasks, or a relationship of a superordinate concept or a subordinate concept.

5. The plan creation system according to claim 1, wherein the information regarding the actual result task includes a level of proficiency of a worker including a simple work level.

6. The plan creation system according to claim 5, wherein the information regarding the actual result task includes a workload per unit period of one worker according to the level of the proficiency.

7. The plan creation system according to claim 1, wherein
the plan creation information includes information regarding a progress state, a worker change, a delivery deadline change, and a specification change for each task indicating whether some of the tasks after the project progresses are completed, and
the at least one processor is configured to execute the instructions to reconstruct a plan in consideration of the progress state, the worker change, the delivery deadline change, and the specification change for each task.

8. The plan creation system according to claim 1, wherein the plan includes task assignment information for assigning a task to a person or a machine.

9. The plan creation system according to claim 1, wherein the classification of the actual result task includes a major item and a minor item included in the major item.

10. The plan creation system according to claim 1, wherein the at least one processor is configured to execute the instructions to create a plurality of plans, and each of the created plans includes information regarding whether each of the received delivery deadline and budget is satisfied.

11. A plan creation method comprising:
receiving plan creation information including a classification of a new project to be created and at least one of a goal, a delivery deadline, or a budget of the new project;
creating a plan based on the received plan creation information by using a trained model trained to output a plan for a project including one or more tasks for implementing the new project using, as inputs, actual result data including a classification of a past project, at least one of a goal, a delivery deadline, or a budget of the past project, and the classification of one or more actual result tasks in which at least one of the goal, the delivery deadline, or the budget of the past project have been achieved; and
outputting the created plan.

12. The plan creation method according to claim 11, further comprising outputting a plan including a plurality of tasks having different granularities according to the classification of the new project to be created.

13. The plan creation method according to claim 11, wherein
a plurality of the actual result tasks that have achieved the goal of the past project includes a relationship among the plurality of actual result tasks, and
the plan creation method further comprises creating a plan including an order relationship between two or more tasks or a parallel relationship between two or more tasks.

14. The plan creation method according to claim 13, wherein the relationship among the plurality of actual result tasks that have achieved the goal of the past project includes at least one of presence or absence of a causal relationship among the plurality of actual result tasks, a temporal order among the plurality of actual result tasks, or a relationship of a superordinate concept or a subordinate concept.

15. The plan creation method according to claim 11, wherein information regarding the actual result task includes a level of proficiency of a worker including a simple work level.

16. A non-transitory computer readable medium storing a program causing a computer to execute processing of the method according to claim 11.

17. The non-transitory computer readable medium according to claim 16, further causing the computer to execute processing of outputting a plan including a plurality of tasks having different granularities according to the classification of the new project to be created.

18. The non-transitory computer readable medium according to claim 16, wherein
a plurality of the actual result tasks that have achieved the goal of the past project includes a relationship among the plurality of actual result tasks, and
the program further causes the computer to execute processing of creating a plan including an order relationship between two or more tasks or a parallel relationship between two or more tasks.

19. The non-transitory computer readable medium according to claim 18, wherein the relationship among the plurality of actual result tasks that have achieved the goal of the past project includes at least one of presence or absence of a causal relationship among the plurality of actual result tasks, a temporal order among the plurality of actual result tasks, or a relationship of a superordinate concept or a subordinate concept.

20. A training device comprising:
at least one memory storing instructions, and
at least one processor configured to execute the instructions to;
acquire training data that is actual result data including a classification of a past project, at least one of a goal, a delivery deadline, or a budget of the past project, and the classification of one or more actual result tasks in which at least one of the goal, the delivery deadline, or the budget of the past project have been achieved; and
trained model trained to output a plan for a project including one or more tasks for implementing a new project using the training data as an input.
